(19) United States
(12) Patent Application Publication
(10) Pub. No.: US 2024/0392050 A1
(43) Pub. Date: Nov. 28, 2024

(54) SUSPENDING AGENT FOR NEGATIVE ELECTRODE SLURRY OF LITHIUM ION BATTERY AND PREPARATION METHOD AND APPLICATION THEREOF

(71) Applicant: JIANGSU YITE NEW MATERIAL CO., LTD, Changzhou, Jiangsu (CN)

(72) Inventors: Wenlong Li, Changzhou, Jiangsu (CN); Jiandong Chen, Changzhou, Jiangsu (CN); Wengang Qi, Changzhou, Jiangsu (CN); Yonghe Wang, Changzhou, Jiangsu (CN)

(21) Appl. No.: 18/429,352

(22) Filed: Jan. 31, 2024

(30) Foreign Application Priority Data
Mar. 20, 2023 (CN) 202310267744.9

(51) Int. Cl. C08F 220/06; H01M 4/02; H01M 4/04; H01M 4/133; H01M 4/583; H01M 4/62

(52) U.S. Cl. CPC C08F 220/06; H01M 4/04; H01M 4/133; H01M 4/583; H01M 4/625; H01M 2004/027

(57) ABSTRACT

Disclosed are a suspending agent for a negative electrode slurry of a lithium ion battery and a preparation method and application thereof. The suspending agent for the negative electrode slurry comprises the following ingredients in parts by weight: 87 parts to 94 parts of main suspending agent, 0.1 part to 1 part of solubilizing agent, 5 parts to 8 parts of synergist, and 0.1 part to 1 part of pH value regulator. According to the invention, by adding the suspending agent into the negative electrode slurry of the lithium ion battery, a traditional negative electrode suspending agent sodium carboxymethyl cellulose (hereinafter referred to as CMC) material can be replaced, the suspending agent has better suspension stability compared with the CMC material, an amount of the suspending agent is reduced compared with the CMC material.

### CROSS-REFERENCE TO RELATED APPLICATION

The present application claims priority from Chinese Patent Application No. 202310267744.9 filed on Mar. 20, 2023, the contents of which are incorporated herein by reference in their entirety.

### TECHNICAL FIELD

The present invention relates to the field of lithium ion batteries, and particularly to a suspending agent for a negative electrode slurry of a lithium ion battery and a preparation method and application thereof.

### BACKGROUND

In recent years, new energy industry has developed rapidly and has become an important link of a future national development plan. Lithium ion battery in the new energy industry has attracted much attention, and the lithium ion battery is usually composed of a positive electrode, a negative electrode, a current collector, a diaphragm and an electrolyte, following a working principle as follows: during charging: LiFePO₄→Li₁₋ₓFePO₄+xLi++x^{e-}, and during discharging: Li₁₋ₓFePO₄+xLi++x^{e-}→LiFePO₄. The negative electrode of the lithium ion battery is prepared by working procedures of coating a negative electrode slurry made of conductive carbon black, graphite and other materials on a copper foil of the current collector, drying and cutting. According to interviews with customers, in an actual production process, there are often the following problems.

1. After using sodium carboxymethyl cellulose (CMC) as a suspending agent, the negative electrode slurry is insufficient in stability, and the sedimentation of carbon materials such as graphite often occurs;

2. An amount of the CMC is large, which leads to large internal resistance and impedance of the battery after the battery is molded, and on the other hand, the large amount causes a high cost; and

3. According to market demand and customer feedback, a discharge rate is expected to be improved.

### SUMMARY

Object of the present invention: in order to solve the technical problems in the prior art, the present invention provides a preparation method of a suspending agent for a negative electrode slurry of a lithium ion battery, which aims to solve the problems of a large amount of CMC in the negative electrode slurry of the lithium ion battery, poor stability of the negative electrode slurry, high internal resistance and impedance of an assembled product, a high cost, and difficult improvement of a battery cell rate in an existing negative electrode slurry of a lithium ion battery.

In order to achieve the above object, the present invention provides a preparation method and application of a suspending agent for a negative electrode slurry of a lithium ion battery, and the suspending agent for the negative electrode slurry comprises the following ingredients in parts by weight: 87 parts to 94 parts of main suspending agent, 0.1 part to 1 part of solubilizing agent, 5 parts to 8 parts of synergist, and 0.1 part to 1 part of pH value regulator, wherein the main suspending agent is any one or a combination of several of polyvinyl alcohol, polyacrylic acid polymer, xanthan gum and inorganic powder; the solubilizing agent is an acidic reagent; and the synergist is a cellulose polymer or a polyol polymer.

The polyacrylic acid polymer is sodium polyacrylate or a polyacrylate cross-linked polymer SEPIMAX ZEN.

In some specific embodiments, the main suspending agent comprises, but is not limited to, polyvinyl alcohol (PVA 1799), sodium polyacrylate (Fengrun), a xanthan gum (Fufeng), a polyacrylate cross-linked polymer (SEPIMAX ZEN), lithium magnesium silicate (Hongbo), and the like.

Preferably, the main suspending agent is a mixture of the sodium polyacrylate, the polyacrylate cross-linked polymer and the lithium magnesium silicate, preferably, a mass ratio of the three substances is 50 to 55:35:2, and more preferably, the main suspending agent is a mixture of the sodium polyacrylate, the polyacrylate cross-linked polymer and the lithium magnesium silicate in a mass ratio of 50:35:2.

The acidic reagent is any one or a combination of several of phosphoric acid, citric acid, acetic acid and oxalic acid.

The synergist is any one or a combination of several of hydroxyethyl cellulose, hydroxypropyl methylcellulose and polyethylene glycol.

The pH value regulator is any one or a combination of several of Na₂HPO₄, NaH₂PO₄ and sodium citrate.

The present invention further provides a preparation method of the suspending agent for the negative electrode slurry of the lithium ion battery above, which comprises the following steps of:
step 1): sequentially adding a main suspending agent and a synergist in a formula ratio into a vacuum disperser, and starting to stir;
step 2): after stirring evenly, carrying out a nitrogen replacement treatment on the disperser, adding a solubilizing agent and a pH value regulator in a formula ratio, sealing the mixture, and starting to stir; and
step 3): discharging according to a packaging specification, and sealing to obtain the suspending agent.

Preferably, in the step 1), the stirring lasts for 2 hours to 3 hours at a stirring speed of 150 rpm to 300 rpm, and in the step 2), a temperature in a tank is kept at 25° C. to 28° C., and the stirring lasts for 1 hour to 2 hours at a stirring speed of 200 rpm to 400 rpm; and more preferably, in the step 1), the stirring lasts for 2 hours at a stirring speed of 200 rpm, and in the step 2), the temperature in the tank is kept at 25° C., and the stirring lasts for 1 hour at a stirring speed of 300 rpm.

The present invention further provides a negative electrode slurry of a lithium ion battery, which comprises the suspending agent for the negative electrode slurry of the lithium ion battery above.

In one specific embodiment, the negative electrode slurry of the lithium ion battery comprises the following ingredients in parts by weight: 94 parts to 97 parts of graphite, 0.5 part to 1.5 parts of conductive carbon black, 0.2 part to 0.8 part of suspending agent, 80 parts to 100 parts of water, and 1 part to 3 parts of styrene-butadiene rubber water (hereinafter referred to as an SBR aqueous solution).

Preferably, a model of the graphite is any one or a combination of several of BTR AGP-3, Shanshan Tech FSN-1 and Kaijin 400.

A model of the conductive carbon black is Li-2060, a model of the styrene-butadiene rubber aqueous solution is Shanghai Sixin LB-422, and the water is ultra-pure water.

Beneficial effects: compared with the prior art, according to the present invention, by adding the suspending agent into the negative electrode slurry of the lithium ion battery, stability of a solid material in the negative electrode slurry is improved, and a large amount of CMC is completely replaced, which reduces internal resistance and impedance of the lithium ion battery after the lithium ion battery is molded, further reduces a cost, and improves a discharge rate at the same time, thus improving or solving the problem of market feedback.

### BRIEF DESCRIPTION OF THE DRAWINGS

FIG. 1 is a diagram of stability of a negative electrode slurry after CMC and a suspending agent are used respectively;

FIG. 2 shows comparison of impedances of a battery in a CMC system and a suspending agent system;

FIG. 3 shows comparison of discharge rates of the battery in the CMC system and the suspending agent system;

FIG. 4 shows comparison of internal resistances of the battery in the CMC system and the suspending agent system; and

FIG. 5 shows states of 0.5% suspending agent aqueous solutions prepared in Embodiments 1 to 6, wherein Embodiments 1 to 6 are sequentially shown from left to right.

### DETAILED DESCRIPTION

The present invention is further described in detail hereinafter with reference to specific embodiments, and the embodiments will help to understand the present invention, but the scope of protection of the present invention is not limited to the following embodiments.

### Embodiment 1 Preparation of Suspending Agent for Negative Electrode Slurry of Lithium Ion Battery

A suspending agent for a negative electrode slurry of a lithium ion battery comprised the following ingredients in parts by weight:

a main suspending agent: 55 Kg of sodium polyacrylate+35 Kg of polyacrylate cross-linked polymer SEPIMAX ZEN+2 Kg of lithium magnesium silicate (Hongbo);
an acidic reagent: 0.1 Kg of phosphoric acid;
a synergist: 5 Kg of hydroxypropyl methylcellulose; and
a pH value regulator: 0.1 Kg of NaH₂PO₄.

### Preparation Method:

step 1): sequentially adding a main suspending agent and a synergist in a formula ratio into a vacuum disperser, and starting to stir for 2 hours at a stirring speed of 200 rpm;
step 2): after stirring evenly, carrying out a nitrogen replacement treatment on the disperser, adding a solubilizing agent and a pH value regulator in a formula ratio, sealing the mixture, starting to stir, keeping a temperature in a tank to be 25° C., and stirring the mixture for 1 hour at a stirring speed of 300 rpm; and
step 3): discharging according to a packaging specification, and sealing to obtain the suspending agent.

### Embodiment 2 Preparation of Suspending Agent for Negative Electrode Slurry of Lithium Ion Battery

A preparation method of the suspending agent was the same as that in Embodiment 1, except that a formula and a formula ratio of the suspending agent were as follows: 54 Kg of sodium polyacrylate, 35 Kg of polyacrylate cross-linked polymer, 2 Kg of lithium magnesium silicate, 0.1 Kg of phosphoric acid, 5 Kg of hydroxypropyl methylcellulose and 0.1 Kg of NaH₂PO₄.

### Embodiment 3 Preparation of Suspending Agent for Negative Electrode Slurry of Lithium Ion Battery

A preparation method of the suspending agent was the same as that in Embodiment 1, except that a formula and a formula ratio of the suspending agent were as follows: 53 Kg of sodium polyacrylate, 35 Kg of polyacrylate cross-linked polymer, 2 Kg of lithium magnesium silicate, 0.1 Kg of phosphoric acid, 5 Kg of hydroxypropyl methylcellulose and 0.1 Kg of NaH₂PO₄.

### Embodiment 4 Preparation of Suspending Agent for Negative Electrode Slurry of Lithium Ion Battery

A preparation method of the suspending agent was the same as that in Embodiment 1, except that a formula and a formula ratio of the suspending agent were as follows: 52 Kg of sodium polyacrylate, 35 Kg of polyacrylate cross-linked polymer, 2 Kg of lithium magnesium silicate, 0.1 Kg of phosphoric acid, 5 Kg of hydroxypropyl methylcellulose and 0.1 Kg of NaH₂PO₄.

### Embodiment 5 Preparation of Suspending Agent for Negative Electrode Slurry of Lithium Ion Battery

A preparation method of the suspending agent was the same as that in Embodiment 1, except that a formula and a formula ratio of the suspending agent were as follows: 51 Kg of sodium polyacrylate, 35 Kg of polyacrylate cross-linked polymer, 2 Kg of lithium magnesium silicate, 0.1 Kg of phosphoric acid, 5 Kg of hydroxypropyl methylcellulose and 0.1 Kg of NaH₂PO₄.

### Embodiment 6 Preparation of Suspending Agent for Negative Electrode Slurry of Lithium Ion Battery

A preparation method of the suspending agent was the same as that in Embodiment 1, except that a formula and a formula ratio of the suspending agent were as follows: 50 Kg of sodium polyacrylate, 35 Kg of polyacrylate cross-linked polymer, 2 Kg of lithium magnesium silicate, 0.1 Kg of phosphoric acid, 5 Kg of hydroxypropyl methylcellulose and 0.1 Kg of NaH₂PO₄.

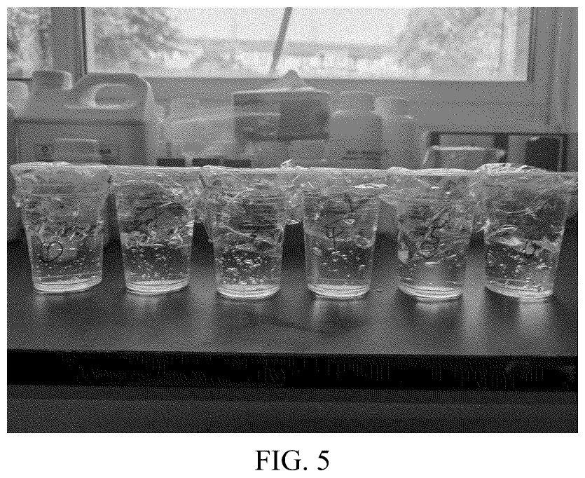

States of the 0.5% suspending agent aqueous solutions prepared in Embodiments 1 to 6 were shown in FIG. 5, and were gel-like.

### Embodiment 7 Preparation of Suspending Agent for Negative Electrode Slurry of Lithium Ion Battery

A preparation method of the suspending agent was the same as that in Embodiment 1, except that a formula and a formula ratio of the suspending agent were as follows: 50 Kg of sodium polyacrylate, 35 Kg of polyacrylic resin, 2 Kg of lithium magnesium silicate, 0.1 Kg of phosphoric acid, 5 Kg of hydroxypropyl methylcellulose and 0.1 Kg of NaH₂PO₄.

In order to facilitate intuitive observation of a material change, weights of the materials used in Embodiments 1 to 7 were summarized in Table 1:

TABLE 1
Use proportions of various materials in Embodiments 1 to 7

| Code of material | 1#/Kg | 2#/Kg | 3#/Kg | 4 /Kg | 5#/Kg | 6#/Kg | 7#/Kg |
|---|---|---|---|---|---|---|---|
| Main suspending | 92 | 91 | 90 | 89 | 88 | 87 | 87 |
| agent | | | | | | | |
| Solubilizing agent | 0.1 | 0.1 | 0.1 | 0.1 | 0.1 | 0.1 | 0.1 |
| Synergist | 5 | 5 | 5 | 5 | 5 | 5 | 5 |
| pH value regulator | 0.1 | 0.1 | 0.1 | 0.1 | 0.1 | 0.1 | 0.1 |

Negative electrode slurries were prepared by using the formulas in Embodiments 1 to 7 as sample suspending agents. A preparation method of the negative electrode slurry comprised the following steps of:

sequentially adding ultra-pure water, graphite (BTR AGP-3), a suspending agent and conductive carbon black (S-P) (Li-2060) into a double-planetary vacuum mixer for mixing, then adding an SBR aqueous solution (Shanghai Sixin LB-422) into the mixed solution, and stirring the mixture to obtain the negative electrode slurry. In the following preparation process, the stirring was carried out by revolution/rotation: 30/1200, and lasted for 4 hours in total.

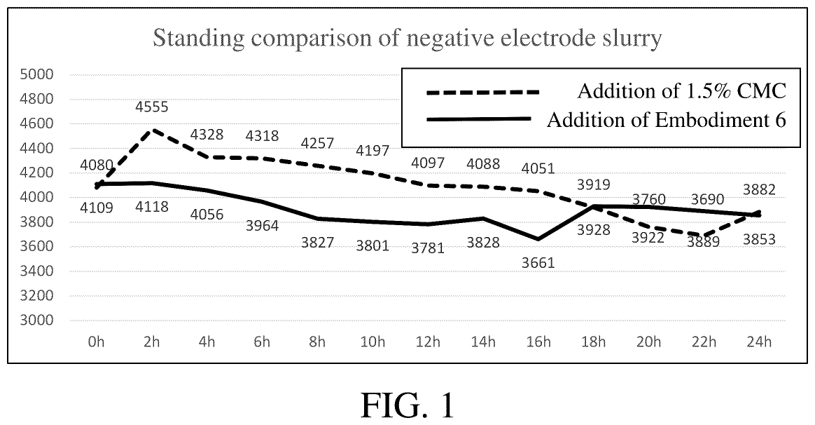

Proportions of the materials used and test results of the negative electrode slurries were summarized in Table 2, test conditions were summarized in Table 3, and stability results were shown in FIG. 1.

TABLE 2
Test data of Embodiments 1 to 7 in the case of
CMC and suspending agent at 53% solid content

| | Solid | 1-hour |
|---|---|---|
| Ratio | content/% | viscosity |
| Graphite:S-P:CMC:SBR:water = | 53.08 | 21397 |
| 95.7:1:1.5:1.8:88.679 | | |
| Graphite:S-P:suspending agent 1^{#}:SBR:water = | 52.93 | 9875.4 |
| 96.7:1:0.5:1.8:88.679 | | |
| Graphite:S-P:suspending agent 2^{#}:SBR:water = | 52.89 | 8542.1 |
| 96.7:1:0.5:1.8:88.679 | | |
| Graphite:S-P:suspending agent 3^{#}:SBR:water = | 52.93 | 7100.3 |
| 96.7:1:0.5:1.8:88.679 | | |
| Graphite:S-P:suspending agent 4^{#}:SBR:water = | 53.08 | 6137.8 |
| 96.7:1:0.5:1.8:88.679 | | |
| Graphite:S-P:suspending agent 5^{#}:SBR:water = | 53.04 | 5068.2 |
| 96.7:1:0.5:1.8:88.679 | | |
| Graphite:S-P:suspending agent 6^{#}:SBR:water = | 53.04 | 4139.8 |
| 96.7:1:0.5:1.8:88.679 | | |
| Graphite:S-P:suspending agent 7^{#}:SBR:water = | 53.11 | 7026.1 |
| 96.7:1:0.5:1.8:88.679 | | |

TABLE 3
Test method of negative electrode slurry

| Test name | Test method | Equipment |
|---|---|---|
| Solid | Drying | Electronic balance |
| content | | and blast drying box |
| Viscosity | Placing in a constant-temperature | NDJ-5S |
| | water bath at 25° C. for 1 hour, | |
| | and measuring 4# rotor at 30 rpm | |
| | for 2 minutes | |

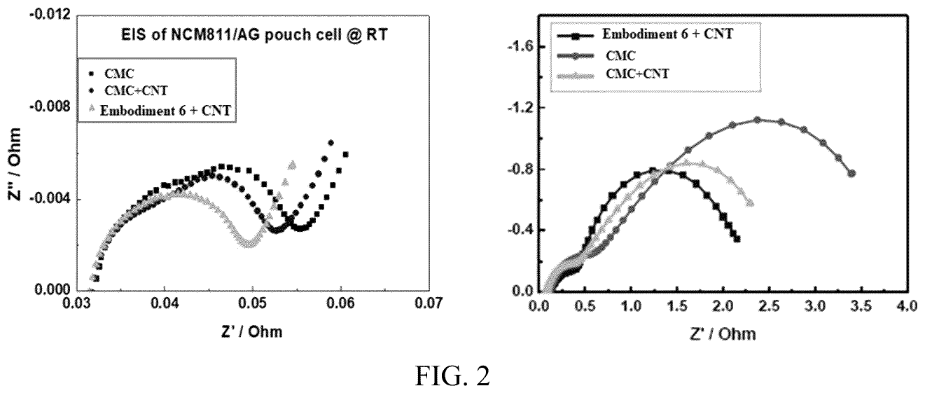

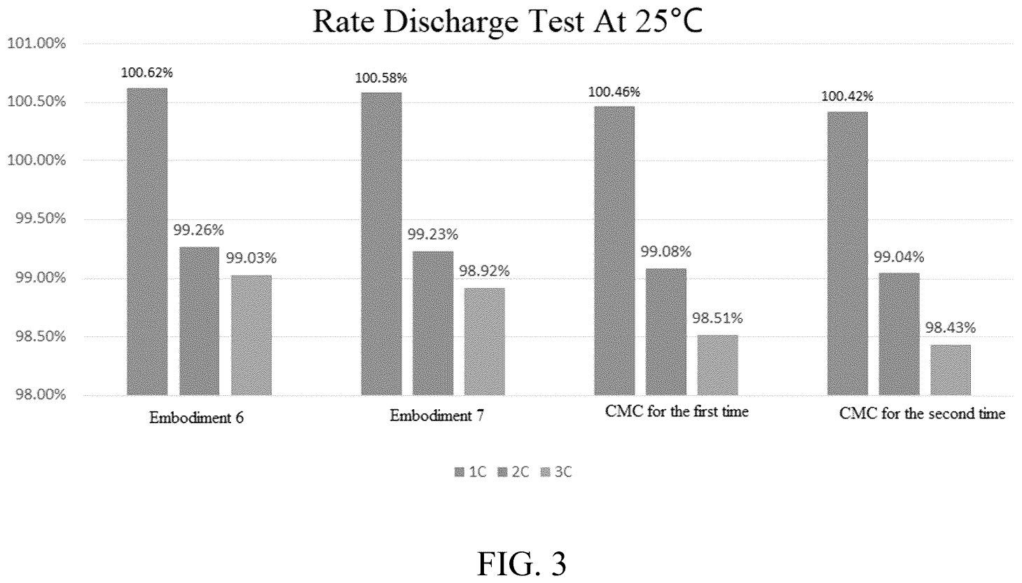

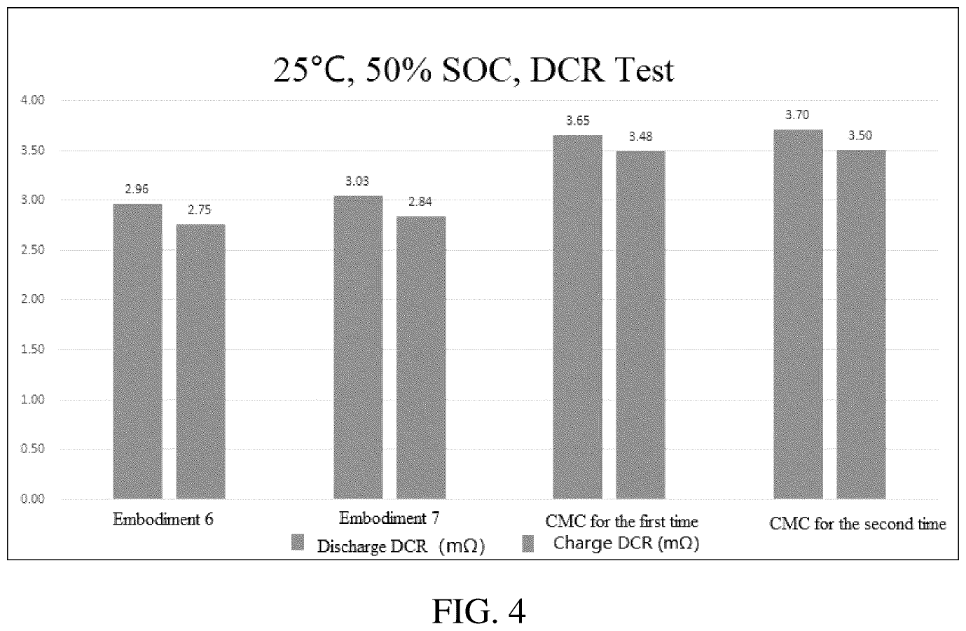

Through observation, Table 2 and customer's experiment show that Embodiment 6 has a better effect; Table 2 and FIG. 1 show that a less amount of new suspending agent needs to be added to achieve the effect compared with the traditional CMC, so that a cost is reduced and the negative electrode slurry has higher stability, as curves shown in FIG. 1; because a content of an organic polymer is reduced, impedance and internal resistance of a finished product of an assembled battery are obviously reduced, as curves shown in FIG. 2 and columns shown in FIG. 4; a discharge rate is improved, as shown in FIG. 3; and real-time feedback is provided after customer's experiment, as shown in Table 4, and results show that this suspending agent really has excellent effect and can replace the CMC material, with obvious advantages in all aspects.

TABLE 4
Experimental result feedback

| | | Target | Experiment + | Production |
|---|---|---|---|---|
| Procedure | Verification item | requirement | Embodiment 6 | line CMC |
| Negative electrode | Viscosity (mPa · s) | 3000-6000 | 4609 | 4180 |
| slurry mixing | Solid content (%) | 52 ± 3 | 54.50% | 52.40% |
| | Slurry stability | No | Good | Good |
| | | abnormality | | |
| | Fineness (μm) | <30 | 24 | 25 |
| Negative electrode | Double-faced areal | 182 ± 3 | 182.5 | 182.4 |
| coating | density (g/m²) | | | |
| | Coating moisture | ≤1000 | 457.2 | 509.6 |
| | (ppm) | | | |
| Negative electrode | Electrode piece | 117 ± 2 | 118.3 | 118.6 |
| rolling | thickness (μm) | | | |
| | Compaction density | 1.65 | 1.64 | 1.63 |
| | Electrode piece before | ≥80 | 181 | 176 |
| | rolling | | | |
| | Peeling strength | | | |
| | (N/m) | | | |

The present invention provides a preparation idea and method for a suspending agent for a negative electrode slurry of a lithium ion battery. There are many methods and ways to realize the technical solution, and the above are only the preferred embodiments of the present invention. It should be pointed out that, for those of ordinary skills in the art, several improvements and decorations may be made without departing from the principle of the present invention, and these improvements and decorations should also be regarded as falling within the scope of protection of the present invention. All the unspecified components in the embodiments can be realized by the prior art.

What is claimed is:

1. A suspending agent for a negative electrode slurry of a lithium ion battery, comprising the following ingredients in parts by weight: 87 parts to 94 parts of main suspending agent, 0.1 part to 1 part of solubilizing agent, 5 parts to 8 parts of synergist, and 0.1 part to 1 part of pH value regulator, wherein the main suspending agent is any one or a combination of several of polyvinyl alcohol, polyacrylic acid polymer, xanthan gum and inorganic powder; the solubilizing agent is an acidic reagent; and the synergist is a cellulose polymer or a polyol polymer.

2. The suspending agent for the negative electrode slurry of the lithium ion battery according to claim 1, wherein the polyacrylic acid polymer is sodium polyacrylate or a polyacrylate cross-linked polymer SEPIMAX ZEN.

3. The suspending agent for the negative electrode slurry of the lithium ion battery according to claim 1, wherein the acidic reagent is any one or a combination of several of phosphoric acid, citric acid, acetic acid and oxalic acid.

4. The suspending agent for the negative electrode slurry of the lithium ion battery according to claim 1, wherein the synergist is any one or a combination of several of hydroxyethyl cellulose, hydroxypropyl methylcellulose and polyethylene glycol.

5. The suspending agent for the negative electrode slurry of the lithium ion battery according to claim 1, wherein the pH value regulator is any one or a combination of several of Na₂HPO₄, NaH₂PO₄ and sodium citrate.

6. A preparation method of the suspending agent for the negative electrode slurry of the lithium ion battery according to claim 1, comprising the following steps of:
step 1): sequentially adding a main suspending agent and a synergist in a formula ratio into a vacuum disperser, and starting to stir;
step 2): after stirring evenly, carrying out a nitrogen replacement treatment on the disperser, adding a solubilizing agent and a pH value regulator in a formula ratio, sealing the mixture, and starting to stir; and
step 3): discharging according to a packaging specification, and sealing to obtain the suspending agent.

7. The preparation method according to claim 6, wherein, in the step 1), the stirring lasts for 2 hours to 3 hours at a stirring speed of 150 rpm to 300 rpm, and in the step 2), a temperature in a tank is kept at 25° C. to 28° C., and the stirring lasts for 1 hour to 2 hours at a stirring speed of 200 rpm to 400 rpm.

8. A negative electrode slurry of a lithium ion battery, comprising the suspending agent for the negative electrode slurry of the lithium ion battery according to claim 1.

9. The negative electrode slurry of the lithium ion battery according to claim 8, comprising the following ingredients in parts by weight: 94 parts to 97 parts of graphite, 0.5 part to 1.5 parts of conductive carbon black, 0.2 part to 0.8 part of suspending agent, 80 parts to 100 parts of water, and 1 part to 3 parts of styrene-butadiene rubber aqueous solution.

10. The negative electrode slurry of the lithium ion battery according to claim 9, wherein a model of the graphite is any one or a combination of several of BTR AGP-3, Shanshan Tech FSN-1 and Kaijin 400, a model of the conductive carbon black is Li-2060, a model of the styrene-butadiene rubber aqueous solution is Shanghai Sixin LB-422, and the water is ultra-pure water.
